(19) United States
(12) Patent Application Publication
(10) Pub. No.: US 2006/0281492 A1
(43) Pub. Date: Dec. 14, 2006

(54) Method and apparatus for subscribers to use a proprietary wireless e-mail and personal information service within a public mobile network not otherwise configured to enable that use

(75) Inventor: John Yue Jun Jiang, Danville, CA (US)

Correspondence Address: ARENT FOX PLLC, 1050 CONNECTICUT AVENUE, N.W., SUITE 400, WASHINGTON, DC, 20036, US

(73) Assignee: Roamware, Inc.

(21) Appl. No.: 11/384,820

(22) Filed: Mar. 21, 2006

Related U.S. Application Data
(63) Continuation-in-part of application No. 10/918,645, filed on Aug. 13, 2004.
(60) Provisional application No. 60/663,787, filed on Mar. 21, 2005.

(51) Int. Cl. H04B 1/38

(52) U.S. Cl. 455/558; 455/458

(57) ABSTRACT

Methods and systems are described herein enabling a local public mobile network that is not configured to offer a certain type proprietary wireless e-mail and personal information service (such as a Blackberry service) to one of its subscribers that otherwise subscribes to such a proprietary service via non-local public network.

### CROSS REFERENCE TO RELATED APPLICATION

This application claims priority from U.S. Provisional Patent Application Ser. No. 60/670,914, entitled “Blackberry Service for Non-Blackberry Networks” filed Mar. 21, 2005, and is a continuation-in-part of U.S. patent application Ser. No. 10/918,645 titled “SIGNALING GATEWAY WITH MULTIPLE IMSI WITH MULTIPLE MSISDN (MIMM) SERVICE IN A SINGLE SIM FOR MULTIPLE ROAMING PARTNERS” filed Aug. 13, 2004. Both of those patent applications are incorporated herein in their entirety by this reference.

### BACKGROUND OF THE INVENTION

1. Field of the Invention

This invention described herein relates to the fields of providing subscribers with wireless mobile communications service within a common carrier public mobile network and to the field of providing those subscribers with access to e-mail, personal information, and other information services.

2. Related Art

Blackberry is a very popular GPRS-based service used all over the world for email/data access. In both Europe and US, and now in many ASPAC countries, local mobile operators offer Blackberry service. So the subscriber can access both voice and Blackberry email/data services on the same phone or wireless mobile communications device.

However, in several regions of the world (such as the Middle East), local cellular providers do not offer Blackberry service. Therefore, subscribers usually end up subscribing to Blackberry service offered by overseas providers mainly in the UK. While many of the operators offer unlimited data/e-mail access at an affordable fixed roaming fee per month anywhere in the world, roaming charges for voice usage are exorbitant. Thus, most Blackberry subscribers in the Middle East end up carrying two wireless mobile communications devices, one for Blackberry data and e-mail over GPRS from the overseas provider, and the other for GSM voice access from the local provider.

Carrying separate devices for voice and data is obviously an inconvenience. There is a need in the art to enable such subscribers to carry a single device, even if the local public mobile network to which they subscribe is not normally equipped to offer Blackberry service, or the wireless e-mail and personal information service of their choice.

Today there are several solutions that offer SIM card modification devices to support two SIM cards in a single mobile wireless device. One SIM card is from the overseas operator that offers the roaming Blackberry-type service and the other is from the LPMN.

However, the problem is that only one SIM card can be active at a time. If the overseas card is active, the subscriber cannot receive or make calls or SMS on the local number. Voice calls and SMS will result in expensive roaming charges. If the local card is active, the subscriber cannot use the Blackberry devices to send or receive emails or information via Blackberry.

The present invention comprises a novel way to solve that problem. It allows both the SIM cards (or rather, both the service subscriptions) to be logically active. It does not even require the subscriber to use the overseas card to get both services. Hence there is no need for handset change or special accessories to hold both cards. The basic idea is to automatically latch on to the data subscription whenever the user latches on to the local voice subscription network.

This can give the LPMN a competitive advantage over other LPMNs that do not provide a unified service on a single device.

### SUMMARY OF THE INVENTION

The present invention comprises a novel way to solve that problem. It allows both the SIM cards (or rather, both the service subscriptions) to be logically active. It does not even require the subscriber to use the overseas card to get both services. Hence there is no need for handset change or special accessories to hold both cards. The basic idea is to automatically latch on to the data subscription whenever the user latches on to the local voice subscription network.

This can give the LPMN a competitive advantage over other LPMNs that do not provide a unified service on a single device.

Service under the present invention would normally be offered by a Local PMN (LPMN), which does not provide Blackberry service, or the type of wireless e-mail and personal information management preferred by the subscriber. (For ease of reference, the term “Blackberry™” while a trademark belonging to Research in Motion, is used generically to refer to such a proprietary service.) The LPMN will offer unified voice and data access from a single device to subscribers who already subscribe to Blackberry service from another wireless network operator (typically an Overseas PMN OPMN) and would like to use the LPMN's voice services. The subscriber will need to get a new LPMN SIM card for this purpose although old number can be kept.

Thus, for optimal operation, service under the present invention normally requires the following:
1. The end-user must subscribe to the roaming Blackberry service of an OPMN or an LPMN that offers Blackberry service.
2. The end-user must use a Blackberry-compatible wireless mobile communications device with a LPMNSIM card
3. The LPMN SIM will have at least voice and SMS service, preferably GPRS service too
4. The LPMNSIM should also have international dialing capability if the OPMN SIM supports international dialing

Once these requirements are met, the Blackberry subscription details will be captured and linked up with the voice subscription details. The user will be told that the network will automatically sign on to the data service on his behalf, and that he should only sign on to the LPMN voice, SMS and GPRS service with the LPMN SIM card.

Once the user signs on to the voice service, he can access voice as well as data service, although part of the data service is from another service provider. The user will be able to use the services seamlessly. He will be able to receive phone calls and SMS while in a data channel communications session.

In addition, if the OPMN profile can make roaming international calls and the LPMN subscriber wants to do the same, then the LPMN subscription also should support international dialing.

When the LPMN subscriber is called on the overseas number. LPMN forwarding numbers will overwrite overseas ones. For example, the voicemail will go to the LPMN voicemail when the MT call to the overseas number is not answered.

The service will only be applied when the subscriber is using the LPMN SIM at the LPMN operator.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 depicts a Signal Packet Gateway Network Architecture for use under the present invention.

FIG. 2 illustrates a flow for GSM location update in conjunction with a supplementary service profile under the present invention.

FIG. 3 illustrates the logical flow of a GSM location update under the present invention.

FIG. 4 illustrates signal flow with an overseas number with a non-local public mobile network under the present invention.

FIG. 5 illustrates signal flow for a mobile terminated SMS MT to an overseas number under the present invention.

FIG. 6 illustrates the flow between local GPRS signaling and a Blackberry service of an overseas operator under the present invention.

### DETAILED DESCRIPTION

Operator Logistics

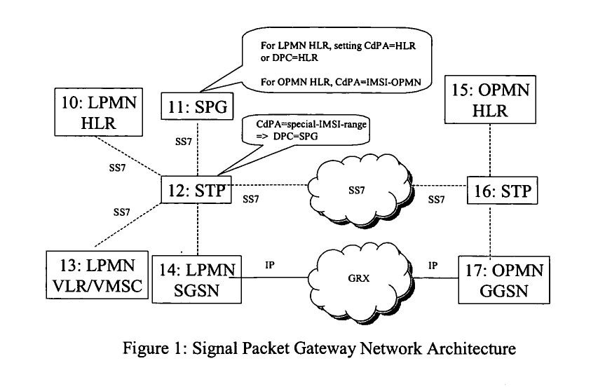

The present invention involves deploying a Signal Packet Gateway (SPG) at the LPMN's SS7 network. FIG. 1 shows the Signal Packet Gateway Network Architecture.

The LPMN operator reserves a special range of IMSIs for subscribers opting for unified Blackberry data and mobile voice service. An LPMN subscriber must be issued a new local SIM card from this range although they don't need to change the original local MSISDN if a local card was already subscribed. The subscriber should also have a local GPRS subscription plan, which can be of a prepaid or postpaid sort.

The LPMN will need to implement a subscription process to capture the mapping between the LPMN subscription profile (IMSI, MSISDN) and the OPMN data subscription explicitly from subscribers. This can be implemented by providing the overseas MSISDN or the overseas SIM to the operator. This mapping is not stored in the HLR but is stored in the database of the SPG.

Using a special range IMSI for the LPMN SIM card allows the operator to set a special E.214 route for all these IMSIs, thereby forcing all their GSM and GPRS location updates to be routed through the SPG 11 and not directly to the LPMN HLR 10. The SPG 11 relays the location updates to the LPMN HLR 10, but also performs an automatic registration into the OPMN HLR 15 for data service.

In a preferred embodiment, the LPMN also provides certain ISUP Loopback circuits or IN triggers between the LPMN MSCs 13 and the SPG 11. The purpose of this feature is to allow the MT calls/SMS on the OPMN number to pass through the SPG 11 to account for billing CDR and to handle OPMN voicemail notification especially for the LPMN subscriber.

The special IMSI range is aimed at allowing the billing system to treat local MT CDRs of the range separately since it may in fact be a MT roaming call/SMS when the OPMN number is called/SMSed. In the case of MT roaming CDR, MT TAP with the corresponding overseas IMSI will need be produced.

Since the Blackberry data service is really on the OPMN IMSI while the LPMN SGSN 14 has the local IMSI record, the special IMSI range will also allow the billing system to treat local SGSN CDR of the range differently. Depending on the APN involved, some may be local GPRS usage and some are really roaming usage. In the case of roaming GPRS CDR, MT TAP with the corresponding overseas IMSI will need be produced.

The LPMN will also need to update its DNS server to map local Blackberry APN to the SPG 11 which can then establish GPRS context with the OPMN GGSN 17.

Technical Approach Overview

Outline of Approach

The proposed solution is extended on an earlier filed patent—SIMM (Single IMSI, Multiple MSISDN) framework that allows a SIM card with a single IMSI to support multiple LPMN profiles. The extension is to support both local and overseas profiles, not just local profiles. The main idea in this framework is to route location updates through the SPG. This gives the SPG the chance to automatically sign on to the second subscription, and also to adjust things such that the SPG is in the path for various call and SMS scenarios. It primarily does this by providing its own address as the serving MSC and VLR address, instead of the real MSC and VLR addresses. This allows it to be the recipient of PRN messages from the HLR and MT-FSM messages from SMSCs, which in turn allows it to control incoming calls and SMS services to the phone.

Besides being in the path for the PRN messages, the SPG also modifies the MSRN in order to be in the call path itself. As mentioned earlier, this allows the SPG to provide billing support.

The proposed solution is also extending GPRS relay technique in another earlier filed patent (Signal Packet Relay System for GPRS). This is because the LPMN SGSN has the LPMN IMSI and OPMN Blackberry APN. The LPMN DNS maps the GGSN of this APN to the SPG. PDC context activation from LPMN SGSN will be established with the SPG that will then relay PDP packets to the real OPMN GGSN by swapping in the OPMN IMSI and faking the LPMN SGSN. Once the PDP session is established, subsequent PDP packets on Blackberry APN from LPMN SGSN will be relayed thru the SPG to the OPMN GGSN and Blackberry service.

The SPG functions like a virtual HLR/VLR/SCP/GMSC/GGSN/SGSN/SMSC etc.

Various Scenarios

When the LPMN IMSI is performing GSM or GPRS location update, the E214 SCCP message is redirected to the SPG. If the location operator is other than the LPMN, SPG simply relays the message out to the real LPMN HLR without further involvement. Only if the location operator is the LPMN, all the following will be applied.

GSM location update and supplementary service profile

When the LPMN IMSI is performing location update, the E214 SCCP message is redirected to the SPG. The SPG will relay the message to the real LPMN HLR. In addition, the SPG will perform GSM location update to the OPMN HLR using the OPMN IMSI and the SPG as the VMSC and VLR address. SPG also establishes the mapping record of the current LPMN location update information and the OPMN location update information.

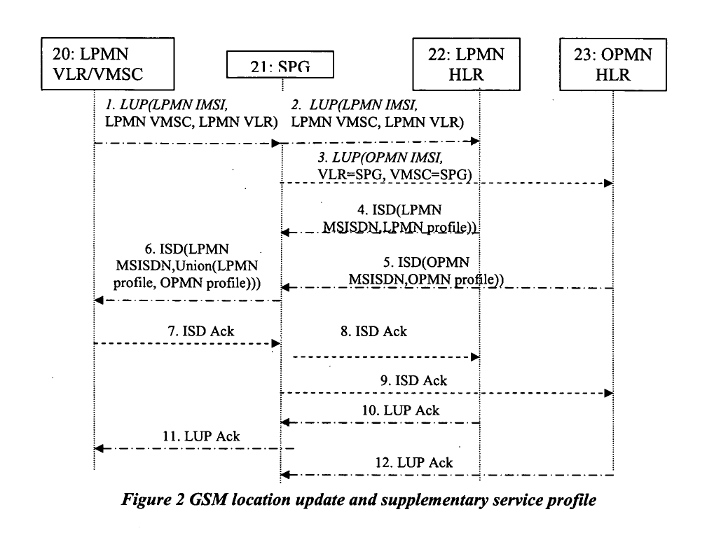

Referring to FIG. 2:
1. When the subscriber registers with LPMN VLR/VMSC 20, the LPMN VLR.VMSC 20 sends Location Update with the LPMN IMSI to SPG 21
2. SPG 21 relays the LUP to the LPMN HLR 22
3. SPG 21 also issues LUP on OPMN IMSI with VLR/VMSC=SPG to the OPMN HLR 23
4. LPMN HLR 22 issues ISD to SPG 21
5. OPMN HLR 23 issues ISD to SPG 21 as well
6. SPG 21 combines the ISD profile from step 4 and step 5, sends to LPMN VLR/VMSC 20
7. LPMN VLR/VMSC 20 issues ISD ack to SPG 21
8. SPG 21 issues ISD ack to LPMN HLR 22
9. SPG 21 issues ISD ack to OPMN HLR 23
10. LPMN HLR 22 issues LUP ack to SPG 21
11. SPG 21 issues LUP ack to LPMN VLR/VMSC 20
12. OPMN HLR 23 issues LUP ACK to SPG 21

The LPMN VLR will have the LPMN subscriber profile including supplementary service such as (e.g. voicemail) forwarding number, MSISDN, call barring on international calls by default. In this case, if the OPMN profile can make international calls at LPMN and the local subscriber wants to do the same, then the local subscription must also have subscription to international dialing.

The LPMN subscriber's late call forwarding numbers will in particular overwrite the OPMN one. So if the LPMN subscriber is not answering the call when his OPMN number is called, then the call goes to the LPMN forwarding number such as voicemail. On the other hand, if his handset is off or roaming profile is purged from the overseas HLR, then MT calls to the overseas number will trigger the early call forwarding (e.g. OPMN voicemail) of the OPMN forwarding numbers of the OPMN subscriber profile.

It is also possible to provide the maximum union of both profiles with local overwriting overseas in case of conflicts. For example, if the local profile does not have capability of making international calls, but overseas profile does, and then overseas profile capability will be sent to the LPMN VLR. Another example, if the local profile does not have the capability of sending international SMS, but overseas profile does, then overseas profile capability will be sent to the LPMN VLR.

On the other hand, if the local has a forwarding number, and the overseas also have one, then the local one will be sent to the LPMN VLR. If the local does not have a forwarding number, but the overseas does, then the VLR will have the overseas forwarding number. Another example, the LPMN MSISDN will always overwrite the OPMN MSISDN when the merged ISD data is sent to the LPMN VLR.

Since the LPMN HLR has the real LPMN VLR, if there is any supplementary service change or local profile change (e.g. MSISDN), then the current VLR profile will have the local profile overwrite rather than a union. For example, if the local profile has turned on international call barring, then the current LPMN VLR will have international call barring. When a new location update comes again, the combined GSM subscription profile from local and overseas will again bring back the international call capability. Of course billing in this case, will always be billed as a roaming call when the local subscriber is making an international call.

Finally, it is also possible to also use SPG as the VLR and VMSC address in the case of local GSM location update. In this way, subsequent and stand alone ISD or DEL from LPMN HLR will come thru the SPG which can then decide the merged data to be sent to the real LPMN VLR.

GPRS location update

When the LPMN IMSI is performing GPRS location update, the E214 SCCP message is redirected to the SPG. The SPG will perform two separate GPRS location updates, one to the LPMN HLR with the SPG as the SCCP CgPA and the other to the OPMN HLR with the SPG GT as the SCCP CgPA and SGSN GT and the SPG IP as the SGSN IP correspondingly.

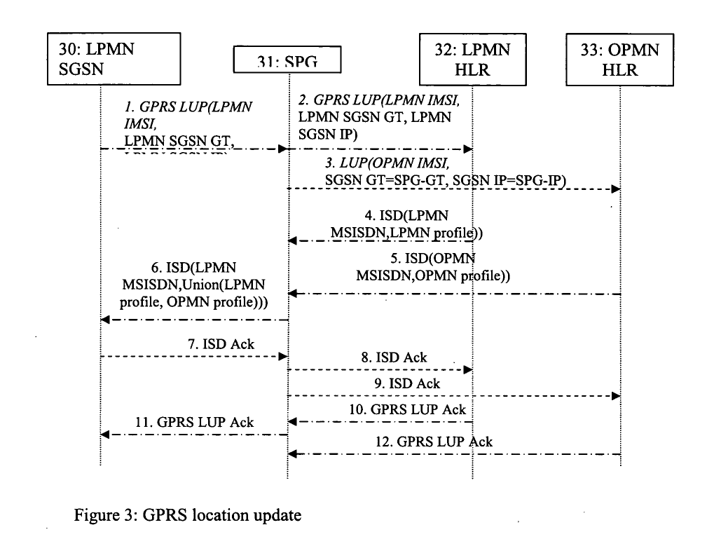

Referring to FIG. 3:
1. When the subscriber registers with LPMN SGSN 30, the LPMN SGSN 30 sends GPRS Location Update with the LPMN IMSI to SPG 31
2. SPG 31 relays the GPRS LUP to the LPMN HLR 32
3. SPG 31 also issues GPRS LUP on OPMN IMSI with SGSN=SPG to the OPMN HLR 33
4. LPMN HLR 32 issues ISD to SPG 31
5. OPMN HLR 33 issues ISD to SPG 31 as well
6. SPG 31 combines the ISD profile from step 4 and step 5, sends to LPMN SGSN 30
7. LPMN SGSN 30 issues ISD ack to SPG 31
8. SPG 31 issues ISD ack to LPMN HLR 32
9. SPG 31 issues ISD ack to OPMN HLR 33
10. LPMN HLR 32 issues LUP ack to SPG 31
11. SPG 31 issues LUP ack to LPMN SGSN 30
12. OPMN HLR 33 issues LUP ACK to SPG 31

When the ISDs are returned from both GPRS location update, the OPMN GPRS profile data such as APN and PDP context profile are merged with those of LPMN GPRS profile. The local non-GPRS profile such as LPMN MSISDN will overwrite the overseas non-GPRS profile. The merged ISD data are then sent to the real LPMN SGSN.

If the local subscriber does not have GPRS subscription, then only the overseas GPRS subscription profile together with the LPMN MSISDN is sent to the LPMN SGSN in the merged ISD data.

SPG also establishes the mapping record of the current LPMN GPRS location update information (such as SGSN GT and IP, non-GPRS profile such as MSISDN) and the OPMN GPRS subscription information (such as OPMEN IMSI and OPMN MSISDN).

Note that the SGSN info in LPMN HLR is the real SGSN info. Whatever GPRS profile changes in LPMN HLR go directly to the SGSN. However the SGSN info in OPMN HLR are the SPG Info instead. Whatever changes in GPRS profile in OPMN HLR go thru the SPG before relayed to the real SGSN after LPMN profile data such as LPMN IMSI and LPMN MSISDN are substituted in place of the OPMN ones.

If the LPMN withdraws local GPRS service, it will affect the current local SGSN profile unless a new location update is sent (e.g. power off/on again or new SGSN is registered).

Finally, it is also possible to use SPG GT and IP as the SGSN number and IP address in the case of relaying local GPRS location update. In this way, subsequent and stand alone ISD or DEL from local HLR will come thru the SPG which can then decide the merged data to be sent to the real SGSN.

MO-call

Call flow is normal local MO-call.

MT-call

To local number

Call flow is normal MT call including early call forwarding and late call forwarding.

To overseas number

OPMN issues MAP SRI to OPMN HLR. OPMN HLR issues PRN to the SPG. SPG will then issue PRN to the real VLR. The real VLR returns MSRN back to the SPG, which will then return a special mapping of MSRN to the OPMN HLR.

When the MT call routed on the special mapping finally reaches the LPMN network, the LPMN switch will pass the call control to the SPG again (either via ISUP loopback or IN trigger), the SPG will then reconnect the call on the real MSRN while at the same time to set up controls for CDR generation.

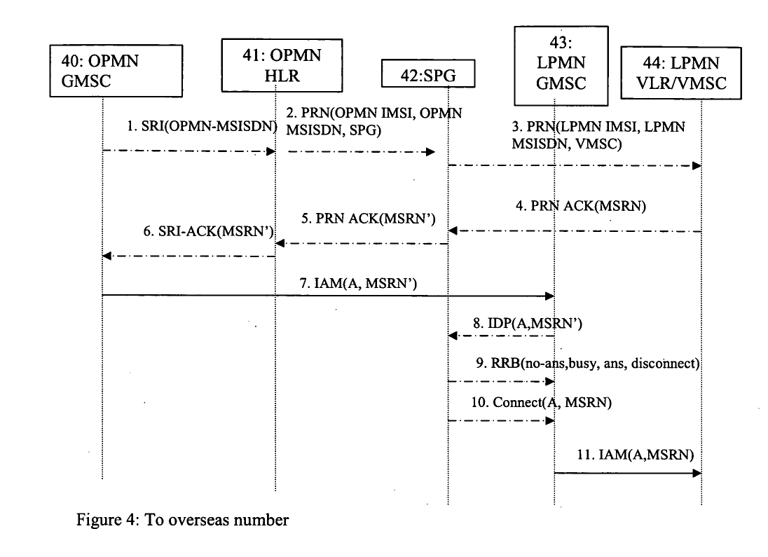

Referring to FIG. 4:
1. When OPMN MSISDN is called, the OPMN GMSC 40 issues SRI(OPMN-MSISDN) to OPMN HLR 41
2. OPMN HLR 41 issues PRN on OPMN IMSI to SPG 42
3. SPG 42 issues PRN on the LPMN IMSI to LPMN VLR/VMSC 44
4. LPMN VLR/VMSC 44 issues PRN Ack(MSRN) to SPG 42
5. SPG 42 issues PRN ACK(MSRN′) to OPMN HLR 41
6. OPMN HLR 41 issues SRI ACK(MSRN′)
7. OPMN GMSC 40 issues ISUP IAM on MSRN′ to LPMN GMSC 43
8. LPMN GMSC 43 issues IDP(A,MSRN′) to SPG 42
9. SPG 42 issues RRB to LPMN GMSC 43
10. SPG 42 issues Connect(A,MSRN) to LPMN GMSC 43
11. LPMN GMSC 43 issues IAM(A,MSRN) to LPMN VMSC/VLR 44
   Late call forwarding

If the MT call to OPMN MSISDN is not answered, the late call forwarding will happen. If the local subscriber has a voicemail, it will go to the local voicemail. If it does not, tromboning to the OPMN voicemail will happen if the OPMN profile has voicemail. Notification of OPMN voicemail will be sent to the local subscriber via SPG, which can then control the content of notification.

Early call forwarding

Early call forwarding profile of OPMN will take place. For example, if there is an,overseas voicemail profile, early call forwarding will go there. Notification of overseas voicemail will be sent to the local subscriber via SPG, which can then control the content of notification.

MO-SMS

Normal MO-SMS always applies.

MT-SMS

To local number

Normal flow applies.

To overseas number

Since OPMN HLR has SPG as the VMSC/SGSN address, MAP forwardSMS will always send the SMS to the SPG first before SPG relays to the real VMSC/SGSN destination.

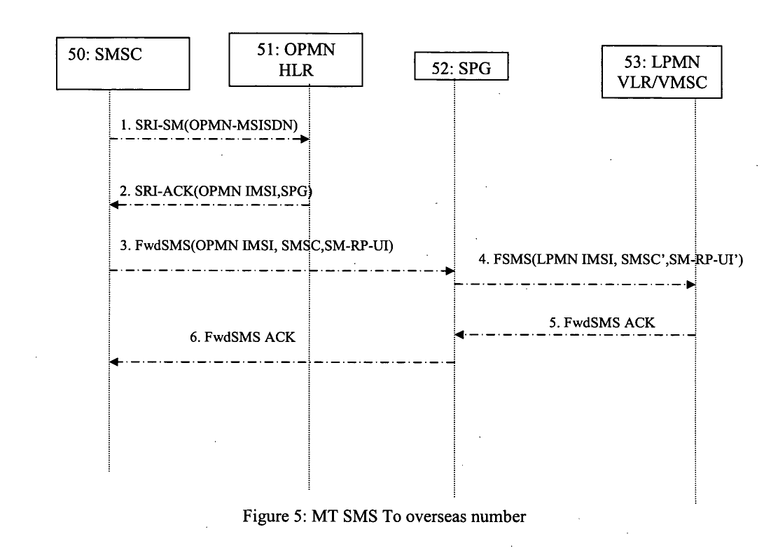

Referring to FIG. 5:
1. SMSC 50 issues SRI-SM(OPMN-MSISDN) to OPMN HLR 51
2. OPMN HLR 51 returns OPMN IMSI and SPG to SMSC 50
3. SMSC 50 forwards SMS on the OPMN IMSI with SMSC address to SPG 52
4. SPG 52 forwards SMS on the LPMN IMSI to the real LPMN VMSC/VLR 53
5. LPMN VMSC/VLR 53 issues ack to SPG 52
6. SPG 52 issues ack to SMSC 50

When the SMS is going thru the SPG, SPG will replace the OPMN IMSI (SM-RP-DA) by the LPMN IMSI and replace the CgPA to SPG GT without changing other SCCP or TCAP parameters (such as TCAP ID). In addition, SPG will mark the SMSC address (SM-RP-OA) with a special prefix before sending out to the real VMSC/SGSN. This is to distinguish MT SMS interworking to LPMN MSISDN from MT SMS roaming to the OPMN MSISDN landed as MT SMS to the LPMN MSISDN in the switch of the LPMN.

SPG can also create CDR if needed.

Notification to voicemail

When the MT SMS is relaying thru the SPG, the SMS content can be examined. If the SMS content indicates voicemail, the SPG can send another SMS to indicate the message for the overseas MSISDN and current counter of overseas voicemails to the subscriber.

GPRS

Blackberry GPRS

When the Blackberry handset with the local SIM is doing a Blackberry.net PDP context activation, the LPMN SGSN will first issue DNS request on Blackberry.net APN with the LPMN as the operator postfix. The LPMN DNS will be configured to translate that to SPG, which is acting as a virtual GGSN.

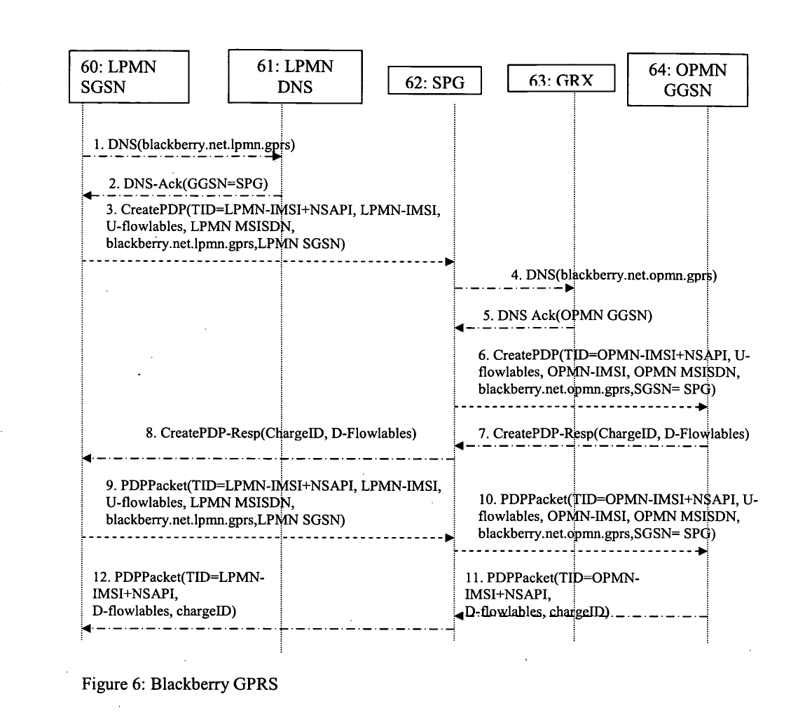

Referring to FIG. 6:
1. LPMN SGSN 60 issues DNS query on Blackberry.net.lpmn.gprs to a LPMN DNS 61
2. The LPMN DNS 61 returns SPG as GGSN to LPMN SGSN 60
3. LPMN SGSN 60 sets up PDP context with SPG 62 using CreatePDP(TID=LPMN−IMSI+NSAPI, LPMN−IMSI, U-flowlables, LPMN MSISDN, Blackberry.net.lpmn.gprs,LPMN SGSN)
4. SPG 62 issues DNS query on Blackberry.net.opmn.gprs to a GRX DNS 63
5. GRX DNS 63 returns OPMN GGSN to SPG 62
6. SPG relays the PDP context from LPMN SGSN to OPMN GGSN 64 but using CreatePDP(TID=OPMN-IMSI+NSAPI, U-flowlables, OP OPMN MSISDN, Blackberry.net.opmn.gprs,SGSN=SPG)
7. OPMN GGSN 64 issues ack back with charging identifier etc to SPG 62.
8. SPG 62 relays the ack back to LPMN SGSN 60
9. LPMN SGSN 60 sends packet to SPG 62
10. SPG 62 relays the packet to OPMN GGSN 64 by changing LMPN IMSI/MSISDN to OPMN IMSI/MSISDN
11. OPMN GGSN 64 sends the packet ack with the charging identifier back to SPG 62
12. SPG 62 sends the packet ack with the charging identifier back to LPMN SGSN 60.

The local SGSN will then try to set up a PDP context with the SPG. The SPG will then issue DNS on the Blackberry.net APN with the overseas operator as the operator postfix. The local DNS or the GRX operator will return the real overseas GGSN.

The SPG will then establish the PDP context with the overseas GGSN with the overseas IMSI and MSISDN. The tunnel ID and billing ID etc are then corresponding mapped into the ones with the local SGSN PDP context.

subsequent packets going from local SGSN to the SPG are then correspondingly translated to packets from SPG to the overseas GGSN. The corresponding translation include using tunnel ID, billing ID, IMSI, MSISDN when necessary.

The GTP version 0 flow is shown above. Similar flow can be shown for GTP version 1 where Tunnel End ID will be used.

Local GPRS

When the Blackberry handset with the local SIM is doing local APNs such as MMS or WAP etc, normal GPRS applies.

Billing

Primarily, the present invention need only address the following:

MO international calls

The following is only applied if the local subscriber is not allowed to make international calls.

When local VMSC CDR is produced, the MO record of the special local IMSI on international numbers will be filtered out first. These records are then deemed to be roaming MO CDR to be sent to the billing system where MO TAP records can be produced.

MT-call overseas number

When local VMSC CDR is produced, the MT record of the special local IMSI will be filtered out first. These records are then reconciled with the MT record at the SPG. Any records not matched are deemed to be local MT CDR to be sent to the billing system. Any records matched are deemed to be roaming MT CDR to be sent to the billing system where MT TAP records can be produced.

Blackberry GPRS service

For GPRS service, SGSN CDR is used generally rather than GGSN CDR for local subscriber service. When the GPRS CDR is produced, the SGSN CDR of the special range of local IMSI with the Blackberry.net APN for the proposed service will be filtered out to the SPG. The SPG will substitute in the overseas IMSI and MSISDN corresponding to the local IMSI and MSISDN in each of the filtered CDR. The translated CDR will be billed as roaming GPRS TAP to the overseas operator by the billing system.

MT SMS interworking/roaming

MT SMS from a foreign SMSC to the local MSISDN is billed as SMS interworking. While MT SMS from the overseas SMSC or foreign SMSC to the roaming MSISDN of the overseas profile is treated as MT SMS roaming and is not billed in general.

However since MT SMS to the overseas MSISDN of the local subscriber of the proposed service will always go thru the Signal Gateway first, the Signal Gateway will mark the overseas SMSC by a special prefix. The switch MT SMS CDR can then filter out the CDRs with this special SMSC prefix to be discarded or billed specially for MT SMS roaming to the overseas operator.

Other Variations

Numerous variations and modifications within the spirit of the present invention will of course occur to those of ordinary skill in the art in view of the embodiments that have now been disclosed. For example, while in the described embodiments, the present invention is implemented primarily from the point of view of GSM mobile networks, the present invention may also be effectively implemented on CDMA, 3G, WCDMA, GPRS, etc., or any other network of common carrier telecommunications in which end users are normally configured to operate within a “home” network to which they normally subscribe, but have the capability of also operating on other neighboring or remote visited networks.

The examples under the present invention, detailed in the illustrative examples contained here, are described using terms and constructs drawn largely from GSM mobile telephony infrastructure, and the proprietary Blackberry system for serving wireless e-mail and personal information. However, use of these examples should not be interpreted to limiting the invention to those media. The capabilities of the visited or non-accustomed network can be of use and provided through any type of telecommunications medium, including without limitation: (i) any mobile telephony network including, without limitation, GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8; (v) any device or system for serving e-mail and personal information to wireless devices such as Windows Mobile, Symbian, PalmOS or any other.

Example embodiments of the present invention have now been described in accordance with the above advantages. It will be appreciated that these examples are merely illustrative of the invention. Many variations and modifications will be apparent to those skilled in the art.

Abbreviations

| Abbreviation | Description |
|---|---|
| 3G | Third generation of mobile |
| BSC | Base Station Controller |
| BCSM | Basic Call State Model |
| CAMEL | Customized Application for Mobile Enhanced |
| | Logic |
| CDMA | Code Division Multiplexed Access |
| CLI | Calling Line Identification |
| CdPA | Called Party Address |
| CgPA | Calling Party Address |
| CAP | Camel Application Part |
| CC | Country Code |
| CB | Call Barring |
| CSI | Camel Subscription Information |
| DPC | Destination Point Code |
| GMSC | Gateway MSC |
| GPRS | General Packet Radio System |
| GLR | Gateway Location Register |
| GSM | Global System for Mobile |
| GSM SSF | GSM Service Switching Function |
| GT | Global Title |
| HLR-H | HLR from HPMN |
| HLR | Home Location Register |
| HPMN | Home Public Mobile Network |
| IMSI | International Mobile Subscriber Identity |
| IN | Intelligent Network |
| ISG | International Signal Gateway |
| INAP | Intelligent Network Application Part |
| ISD | MAP Insert Subscriber Data |
| IAM | Initial Address Message |
| IDP | Initial DP IN/CAP message |
| ISUP | ISDN User Part |
| LUP | MAP Location Update |
| MAP | Mobile Application Part |
| MCC | Mobile Country Code |
| MCC | Mobile Country Code |
| ME | Mobile Equipment |
| MNC | Mobile Network Code |
| MO | Mobile Originated |
| MSC | Mobile Switching Center |
| MSISDN | Mobile Subscriber ISDN Number |
| MSRN | Mobile Subscriber Roaming Number |
| MT | Mobile Terminated |
| MTP | Message Transfer Part |
| NP | Numbering Plan |
| NPI | Numbering Plan Indicator |
| NDC | National Dialing Code |
| ODB | Operator Determined Barring |
| OTA | Over The Air |
| O-CSI | Originating CAMEL Subscription Information |
| PRN | Provide Roaming Number |
| RNA | Roaming Not Allowed |
| RR | Roaming Restricted due to unsupported feature |
| RI | Routing Indicator |
| SPC | Signal Point Code |
| SRI | Send Routing Information |
| SCCP | Signal Connection Control part |
| STP | Signal Transfer Point |
| STP-H | HPMN STP |
| SRI-SM | Send Routing Information For Short Message |
| SSP | Service Switch Point |
| SSN | Sub System Number |
| SIM | Subscriber Identify Module |
| STK | SIM Tool Kit Application |
| SM-RP-UI | Short Message Relay Protocol User Information |
| STP | Signal Transfer Point |
| SS | Supplementary Services |
| TR | Traffic Redirection |
| T-CSI | Terminating CAMEL Service Information |
| TP | SMS Transport Protocol |
| UDHI | User Data Header Indicator |
| UDH | User Data Header |
| UD | User Data |
| VAS | Value Added Service |
| VLR-V | VLR from VPMN |
| VLR | Visited Location Register |
| VMSC | Visited Mobile Switching Center |
| VPMN | Visited Public Mobile Network |

Technical references GSM 902, Q76X, Q71X, Q70X, Q77X, GSM 360, GSM 340, GSM 960, GSM-23060, GSM29060, Q121X U.S. patent application Ser. No. 10/918,644 U.S. patent application Ser. No. 10/778,861 “Signaling and Packet Relay Including General Packet Radio Service (“GPRS”)“MULTIPLE IMSI WITH MULTIPLE/SINGLE MSISDN (MIMM/MISM) SERVICE IN A MULTIPLE SIMS FOR A SINGLE OPERATOR” U.S. patent application Ser. No. 10/918,645 “SIGNALING GATEWAY WITH MULTIPLE IMSI WITH MULTIPLE MSISDN (MIMM) SERVICE IN A SINGLE SIM FOR MULTIPLE ROAMING PARTNERS”

1. A method for availing a subscriber to a local mobile public network of a proprietary e-mail service provided to that subscriber by a non-local public mobile network, the method comprising:
defining a specified set of IMSIs;
providing the subscriber with an identity module for their wireless communications device corresponding to one of said set of IMSIs;
the local public mobile network registering to the non-local public network according to the subscriber's registration information for the proprietary e-mail service;
the non-local public network receiving e-mail from that proprietary e-mail service and communicating that information to the local mobile public network; and
the local public network communicating that e-mail to the subscriber.
